(19) United States
(12) Patent Application Publication
(10) Pub. No.: US 2006/0153317 A1
(43) Pub. Date: Jul. 13, 2006

(54) Digital video broadcasting terrestrial receivers and methods that select channels and fast fourier transform windows

(75) Inventors: Junling Zhang, Gyeonggi-do (KR); Kyu-man Lee, Seoul (KR); Sato Masaki, Gyeonggi-do (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/195,476

(22) Filed: Aug. 2, 2005

(30) Foreign Application Priority Data
Jan. 7, 2005 (KR) 2005-0001528

(51) Int. Cl. H04L 27/06; H04B 1/10

(52) U.S. Cl. 375/344; 375/350

(57) ABSTRACT

Digital video broadcasting terrestrial (DVB-T) receivers include a fast Fourier transformer that is configured to generate a frequency domain signal from a demodulated DVB-T signal using a range of a window, and an equalizer that is configured to equalize the frequency domain signal according to a channel selection to generate an equalized frequency domain signal. A controller is responsive to a bit error rate of the equalized frequency domain signal to control the channel selection for the equalizer, and to control the range of the window used by the fast Fourier transformer.

### CROSS REFERENCE TO RELATED APPLICATION

This application claims the benefit under 35 USC § 119 of Korean Patent Application No. 2005-0001528, filed on Jan. 7, 2005, the disclosure of which is hereby incorporated herein by reference in its entirety as if set forth fully herein.

### FIELD OF THE INVENTION

The present invention relates to digital video broadcasting terrestrial (DVB-T) systems and methods, and more particularly, to DVB-T receivers and receiving methods.

### BACKGROUND OF THE INVENTION

In general, digital TV (DTV) transmission may employ vestigial sideband transmission, which is a single carrier modulation, and/or Coded Orthogonal Frequency Division Multiplexing (COFDM), which is a multi-carrier modulation. DVB-T modulation/demodulation uses Orthogonal Frequency Division Multiplexing (OFDM) for terrestrial broadcasting of digital television signals. OFDM is a method of digital modulation in which information is spilt into several parts and transmitted at different carrier frequencies. OFDM receivers may process the received signals via a multipath channel.

FIG. 1 is a block diagram of a conventional DVB-T receiver. Referring to FIG. 1, the DVB-T receiver includes an analog-to-digital converter (ADC) 1, a demodulator 2, a coarse symbol timing recovery (STR) & carrier recovery (CR) block 3, a Fast Fourier Transform (FFT) block 4, a fine CR block 5, an adder (summer) 6, a number controlled oscillator (NCO) 7, a fine STR block 8, an equalizer 9, a Viterbi decoder 10, a Reed-Solomon decoder 11, and a bit error rate (BER) calculator 12.

The ADC 1 samples an analog signal γ(t) transmitted from a DVB-T transmitter (not shown) using a fixed frequency signal.

The demodulator 2 generates a complex signal γ(n) by demodulating the sampled signal from the ADC 1 in response to a sampling frequency offset signal OS1 offset from a sampling clock signal, and complex carrier signals Sin(*) and Cos(*). The fine offset signal OS1 is used to compensate for a sampling frequency offset generated by the ADC 1. Since the analog signal γ(t) is modulated by the transmitter, it is demodulated by the DVB-T receiver.

The Coarse STR & CR block 3 receives the complex signal γ(n), generates information regarding a starting point of a coarse FFT of the FFT block 4, sends the information to the FFT block 4, and creates a coarse frequency offset signal containing frequency offset information regarding the complex carrier signals Sin(*) and Cos(*). The coarse frequency offset signal is then transmitted to the adder 6.

Upon receiving the information regarding the starting point of the coarse FFT and a fine offset signal OS2 regarding the starting point of FFT, the FFT block 4 generates a frequency domain complex signal Rₖ(m) by canceling a guard interval (GI) from the complex signal γ(n). The frequency domain complex signal Rₖ(m) is a complex signal of an m^{th} subcarrier in a k^{th} OFDM symbol (where k and m are integers).

The Fine CR block 5 generates a fine carrier frequency offset signal contained in the complex carrier signals Sin(*) and Cos(*), using the frequency domain complex signal Rₖ(m).

The adder 6 combines the coarse offset signal output from the coarse STR & CR block 3 and the fine carrier frequency offset signal output from the fine CR block 5.

The NCO 7 generates the complex carrier signals Sin(*) and Cos(*) using the results of combination output from the adder 6.

The fine STR block 8 generates the sampling frequency offset signal OS1 and the FFT start position fine offset signal OS2 in response to the frequency domain complex signal Rₖ(m).

The equalizer 9 performs channel estimation and compensation on the frequency domain complex signal Rₖ(m).

The Viterbi decoder 10 obtains a real signal by Viterbi decoding the compensated frequency domain complex signal output from the equalizer 9.

The Reed-Solomon decoder 11 generates a transport stream (TS) from the real frequency signal output from the Viterbi decoder 10.

The BER calculator 12 calculates a quasi bit error rate (BER) by comparing the real signal output from the Viterbi decoder 10 with the TS stream output from the Reed-Solomon decoder 11.

FIG. 2 is a block diagram of the equalizer 9 of FIG. 1. Referring to FIG. 2, the equalizer 9 includes a time domain interpolator 201, a frequency domain interpolator 202, and a compensator 203.

The time domain interpolator 201 interpolates scattered pilots of the frequency domain complex signal Rₖ(m) (mε[Kₘᵢₙ, Kₘₐₓ]) in a time domain. Kₘᵢₙ and Kₘₐₓ denote a minimum value and a maximum value of the subcarrier index of each OFDM symbol. According to the DVB-T standard, a sample is supposed to be obtained by performing Channel Impulse Response (CIR) estimation on every three subcarriers in a frequency domain after the interpolation in the time domain.

The frequency domain interpolator 202 interpolates a signal output from the time domain interpolator 201 in the frequency domain.

The compensator 203 performs compensation by dividing the frequency domain complex signal Rₖ(m) with the signal output from the frequency domain interpolator 202.

FIG. 3 illustrates the details of a two-ray multipath channel with channel profile path 1 and path 2, and four FFT windows therefor. In detail, (A) of FIG. 3 illustrates the channel profiles of the multipath signals path 1 and path 2. (B) of FIG. 3 illustrates the data structures of the received signals via a multipath channel shown in (A) of FIG. 3. (C) of FIG. 3 illustrates the ranges of the four FFT windows. (D) of FIG. 3 illustrates a process of estimating a CIR demodulated using a first FFT window. (E) of FIG. 3 illustrates a process of estimating a CIR demodulated using a second FFT window. (F) of FIG. 3 illustrates a process of estimating a CIR demodulated using a third FFT window. (G) of FIG. 3 illustrates a process of estimating a CIR demodulated using a fourth FFT window.

Referring to (A) of FIG. 3, the amplitude of the first path signal path 1 is greater than that of the second path signal path 2.

Referring to (B) of FIG. 3, a k^{th} OFDM symbol is activated for a symbol duration Tᵤ, and the time spread τ of the two-ray multipath signal is greater than the GI of the OFDM signal.

Referring to (C) of FIG. 3, the durations of the first through fourth FFT windows are equal to one another, but they start at different times. It is possible to detect an optimum window by performing an operation on the first through fourth FFT windows.

Referring to FIG. 3, it is assumed that the first FFT window begins at the interface between the GI and the k^{th} OFDM symbol of the first path signal path 1, the second FFT window begins at the interface between the GI and the k^{th} OFDM symbol of the second path signal path 2, the third FFT window begins at the starting point of the GI of the second path signal path 2, and the fourth FFT window begins at the starting point of the GI of the first path signal path 1.

Referring to (D) through (G) of FIG. 3, the channel impulse responses of the path signals path 1 and path 2 in the three parts are illustrated since it is assumed that there is one CIR estimation of every three subcarriers after time domain interpolation. Here, long, dashed arrows indicate the channel impulse responses Path 1-1, Path 1-2, and Path 1-3 of the first path signal path 1. Short, solid arrows indicate the channel impulse responses Path 2-1, Path 2-2, and Path 2-3 of the second path signal path 2.

### SUMMARY OF THE INVENTION

Digital video broadcasting terrestrial (DVB-T) receivers according to exemplary embodiments of the present invention include a fast Fourier transformer that is configured to generate a frequency domain signal from a demodulated DVB-T signal using a range of a window, and an equalizer that is configured to equalize the frequency domain signal according to a channel selection to generate an equalized frequency domain signal. A controller is responsive to a bit error rate of the equalized frequency domain signal to control the channel selection for the equalizer, and to control the range of the window used by the fast Fourier transformer. In some embodiments, the controller is configured to maintain the channel selection for the equalizer and the range of the window used by the fast Fourier transformer in response to a decreasing bit error rate, and to change the channel selection for the equalizer and the range of the window used by the fast Fourier transformer in response to an increasing bit error rate. Analogous methods and computer program products also may be provided. Accordingly, DVB-T receivers, methods and computer program products according to embodiments of the invention can include a plurality of channels that are capable of processing multipath signals, and allow selection of a channel and a range of a fast Fourier transform window used in the selected channels.

According to other exemplary embodiments of the present invention, there is provided a DVB-T receiver that includes an analog-to-digital converter (ADC), a demodulator, a symbol timing recovery (STR) and carrier recovery (CR) block, an FFT block, a fine CR block, an adder, a number-controlled oscillator (NCO), a fine STR block, an equalizer, a Viterbi decoder, a Reed-Solomon decoder, a bit rate error (BER) calculator and an STR controller.

The FFT block receives a coarse offset signal regarding an FFT starting point from the STR & CR block, a fine offset signal regarding the FFT starting point, and a window movement indication signal indicating that a window used during an FFT operation should be adjusted, and generates a frequency domain complex signal Rₖ(m) by subtracting a guard interval from a complex signal. The frequency domain complex signal is a complex signal of an m^{th} subcarrier in a k^{th} Orthogonal Frequency Division Multiplexing (OFDM) symbol (m and k are integers).

The equalizer performs channel estimation and compensation by performing a predetermined operation on the frequency domain complex signal output from the FFT block in response to a channel selection signal for channel selection.

The STR controller generates the channel selection signal for channel selection, and the window movement indication signal indicating that a window used during an FFT operation should be adjusted, based on a BER value output from the BER calculator.

According to other exemplary embodiments of the present invention, methods are provided for selecting a channel and a FFT window to be used in a DVB-T receiver, which includes a plurality of channels capable of demodulating an input multipath signal. According to these exemplary methods, a first BER value is computed by setting the value of the channel selection signal and the value of a window movement indication signal to predetermined values, and demodulating an input multipath signal using the predetermined values. A second BER value is computed by changing the values of the channel selection signal and the window movement indication signal, and demodulating the input multipath signal using the changed values. A channel and a window range to be used to demodulate the input multipath signal is determined by comparing the first and second BER values. The channel selection signal designates one of the plurality of channels and the window movement indication signal indicates that the range of the window is to be adjusted when demodulating the received multipath signal using an FFT operation on the designated channel.

### BRIEF DESCRIPTION OF THE DRAWINGS

FIG. 1 is a block diagram of a conventional DVB-T receiver;

FIG. 2 is a block diagram of an equalizer of FIG. 1;

FIG. 3 illustrates details of a two-ray multipath channel and four FFT windows for the two-ray multipath channel;

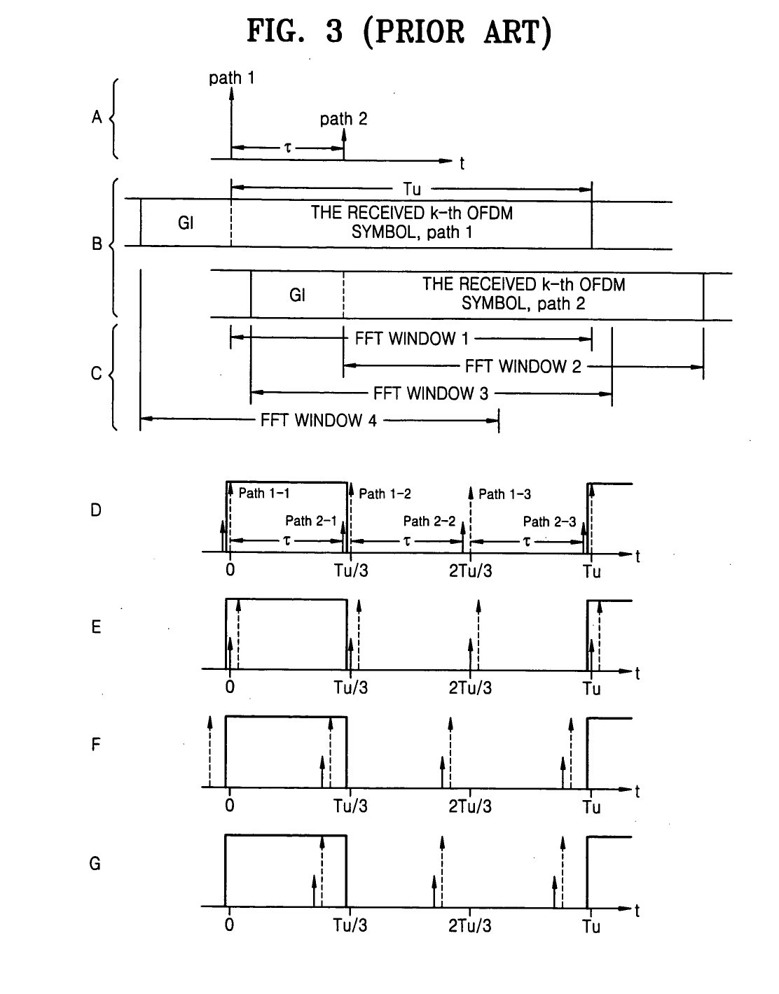

FIG. 4 is a block diagram of a DVB-T receiver and receiving methods according to exemplary embodiments of the present invention;

FIG. 5 is a block diagram of an equalizer and equalizing methods of FIG. 4 according to exemplary embodiments of the present invention; and

FIG. 6 illustrates details of a two-ray multipath channel and four FFT windows for the two-ray channel according to exemplary embodiments of the present invention.

### DETAILED DESCRIPTION

The present invention now will be described more fully hereinafter with reference to the accompanying drawings, in which illustrative embodiments of the invention are shown. However, this invention may be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “coupled”, “connected” or “responsive” to another element, it can be directly coupled, connected or responsive to the other element or intervening elements may also be present. In contrast, when an element is referred to as being “directly coupled”, “directly connected” or “directly responsive” to another element, there are no intervening elements present. Like numbers refer to like elements throughout. As used herein the term “and/or” includes any and all combinations of one or more of the associated listed items and may be abbreviated by “/”.

It will also be understood that, although the terms first, second, etc. may be used herein to describe various elements, these elements should not be limited by these terms. These terms are only used to distinguish one element from another element.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention is described in part below with reference to block diagrams of methods, systems and computer program products according to embodiments of the invention. It will be understood that a block of the block diagrams, and combinations of blocks in the block diagrams, may be implemented at least in part by computer program instructions. These computer program instructions may be provided to one or more enterprise, application, personal, pervasive and/or embedded computer systems, such that the instructions, which execute via the computer system(s) create means, modules, devices or methods for implementing the functions/acts specified in the block diagram block or blocks. Combinations of general purpose computer systems and/or special purpose hardware also may be used in other embodiments.

These computer program instructions may also be stored in memory of the computer system(s) that can direct the computer system(s) to function in a particular manner, such that the instructions stored in the memory produce an article of manufacture including computer-readable program code which implements the functions/acts specified in block or blocks. The computer program instructions may also be loaded into the computer system(s) to cause a series of operational steps to be performed by the computer system(s) to produce a computer implemented process such that the instructions which execute on the processor provide steps for implementing the functions/acts specified in the block or blocks. Accordingly, a given block or blocks of the block diagrams provides support for methods, computer program products and/or systems (structural and/or means-plus-function). Finally, the functionality of one or more blocks may be separated and/or combined with that of other blocks.

A DVB-T receiver according to exemplary embodiments of the present invention includes a plurality of channels for processing a plurality of input path signals and selects a channel, such as an optimum channel, which can demodulate the multipath signals from the plurality of channels. The optimum channel and an optimum range of a Fast Fourier Transform (FFT) window are selected, according to exemplary embodiments of the invention, by measuring channel impulse responses of a multipath channel while changing the range of the FFT window for each of the channels.

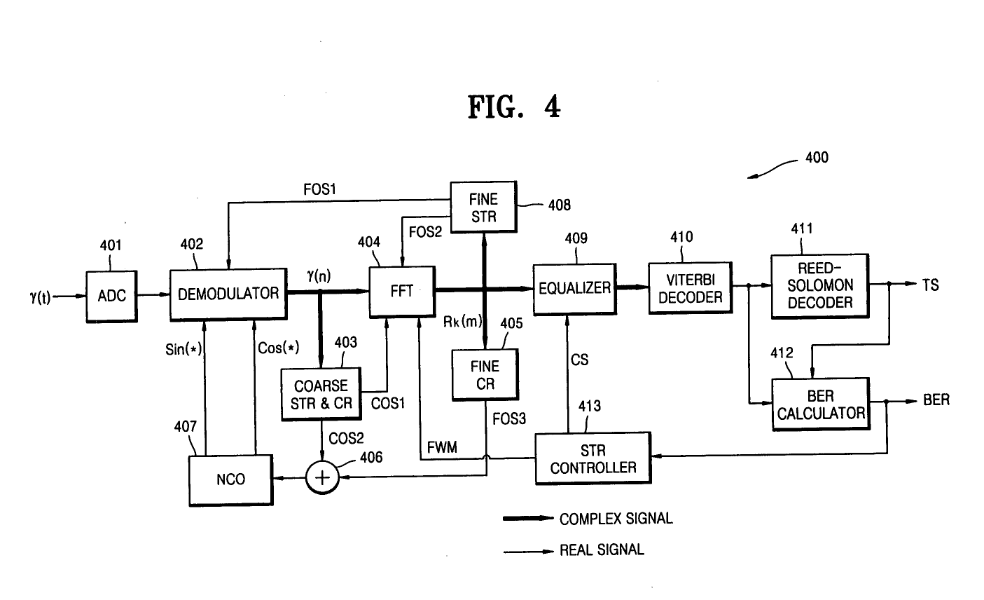

FIG. 4 is a block diagram of a DVB-T receiver 400 according to exemplary embodiments of the present invention. Referring to FIG. 4, the DVB-T receiver 400 includes an analog-to-digital converter (ADC) 401, a demodulator 402, a coarse symbol timing recovery (STR) & carrier recovery (CR) block 403, an FFT block 404, a fine CR block 405, an adder (summer node) 406, a number controlled oscillator (NCO) 407, a fine STR block 408, an equalizer 409, a Viterbi decoder 410, a Reed-Solomon decoder 411, a bit error rate (BER) calculator 412, and an STR controller 413. In FIG. 4, bold arrows indicate lines carrying complex signals, and fine arrows indicate lines carrying real signals.

The ADC 401 samples an analog signal γ(t) transmitted from a DVB-T transmitter (not shown).

The demodulator 402 demodulates the analog signal γ(t) sampled by the ADC 401 and outputs a complex signal γ(n) in response to a precise frequency offset signal FOS1 offset from of a sampling signal and complex carrier signals Sin(*) and Cos(*).

The coarse STR & CR block 403 receives the complex signal γ(n), and generates a coarse offset signal COS1 indicating the starting point of the FFT block 404 and a coarse frequency offset signal COS2 containing frequency offset information regarding the complex carrier signals Sin(*) and Cos(*).

When the coarse offset signal COS1, a precise offset signal FOS2 indicating the starting point of the FFT, and a window movement indication signal FWM are input to the FFT block 404, the FFT block 404 generates a frequency domain complex signal Rₖ(m), at least in part by subtracting a guard interval (GI) from the complex signal γ(n). The frequency domain complex signal Rₖ(m) is a complex signal of an m^{th} subcarrier in a k^{th} Orthogonal Frequency Division Multiplexing (OFDM) symbol (where k and m are integers).

The fine CR block 405 generates a precise frequency offset signal FOS3 containing frequency offset information regarding the complex carrier signals Sin(*) and Cos(*) from the frequency domain complex signal Rₖ(m) output from the FFT block 404.

The adder 406 combines the coarse frequency offset signal COS2 and the precise frequency offset signal FOS3.

The NCO 407 generates the complex carrier signals Sin(*) and Cos(*) in response to a signal output from the adder 406.

The fine STR block 408 creates the precise frequency offset signal FOS1 containing the frequency offset information regarding the complex carrier signals Sin(*) and Cos(*) and the precise offset signal FOS2 indicating a starting point of the FFT, which are included in the frequency domain complex signal Rₖ(m) output from the FFT block 404.

The equalizer 409 performs channel estimation and compensation by performing a predetermined operation on the frequency domain complex signal Rₖ(m) output from the FFT block 404, in response to a channel selection signal CS.

The Viterbi decoder 410 Viterbi decodes the compensated frequency domain complex signal Rₖ(m) output from the equalizer 409, and outputs a real signal.

The Reed-Solomon decoder 411 generates a transport stream (TS) from the real signal output from the Viterbi decoder 410.

The BER calculator 412 computes a BER value by comparing the real signal output from the Viterbi decoder 410 with a signal output from the Reed-Solomon decoder 411.

Using the BER value output from the BER calculator 412, the STR controller 413 generates the channel selection signal CS for channel selection and the window movement indication signal FWM indicating adjustment of the range of a window to be used during an FFT operation. When a system is initialized or power (e.g., power-on reset) is initially supplied to the system, both the window movement indication signal FWM and the channel selection signal CS are reset.

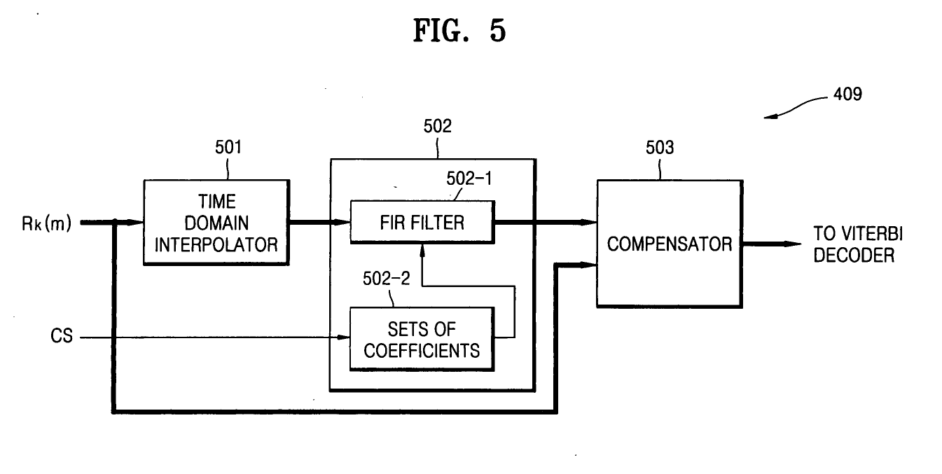

FIG. 5 is a block diagram of an equalizer 409 of FIG. 4 according to exemplary embodiments of the invention. Referring to FIG. 5, the equalizer 409 includes a time domain interpolator 501, a frequency domain interpolator 502, and a compensator 503.

The time domain interpolator 501 interpolates the frequency domain complex signal Rₖ(m) in the time domain.

The frequency domain interpolator 502 includes a finite impulse response (FIR) filter 502-1 and a filter coefficient storage unit 502-2. The frequency domain interpolator 502 interpolates a signal output from the time domain interpolator 502 in the frequency domain in response to the channel selection signal CS.

The FIR filter 502-1 filters the signal output from the time domain interpolator 501 using coefficients received from the filter coefficient storage unit 502-2. The filter coefficient storage unit 502-2 stores two different types of filter coefficients and outputs filter coefficients corresponding to the channel selection signal CS. The band characteristics of the FIR filter 502-1 are determined by the coefficients output from the filter coefficient storage unit 502-2. For instance, the band characteristics of the FIR filter 502-1 are set to correspond to a first channel when the channel selection signal CS has a logic value of 0, and set to correspond to a second channel when the channel selection signal CS has a logic value of 1.

The compensator 503 performs compensation by dividing the complex signal Rₖ(m) with a signal output from the frequency domain interpolator 502.

The construction and operation of a DVB-T receiver according to an embodiment of the present invention will now be described briefly. Although the DVB-T receiver can include more than two channels, it is assumed herein that there are two channels in the DVB-T receiver and that the two channels process two path signals, for convenience. Hereinafter, the two channels will be referred to as echo channels so that they can be differentiated from general channels.

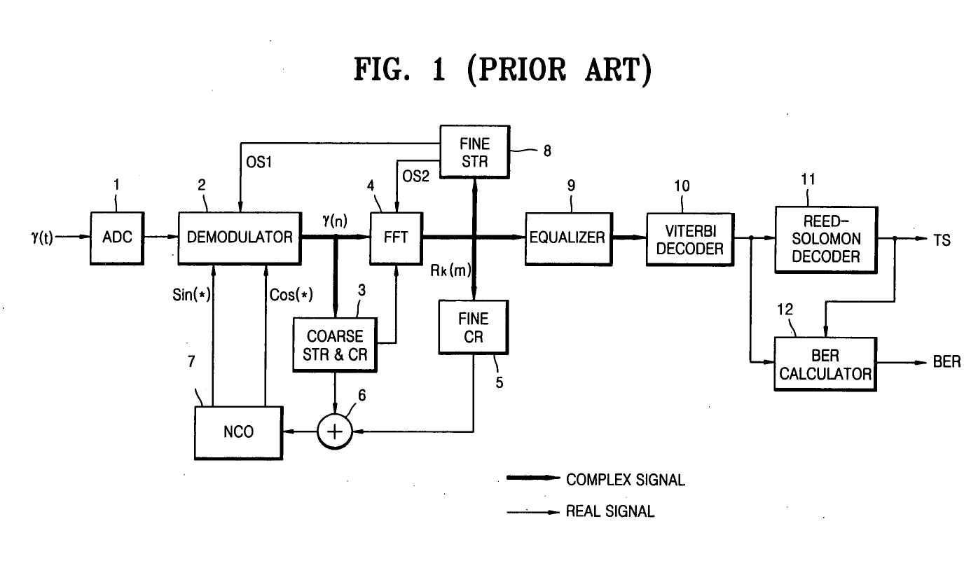

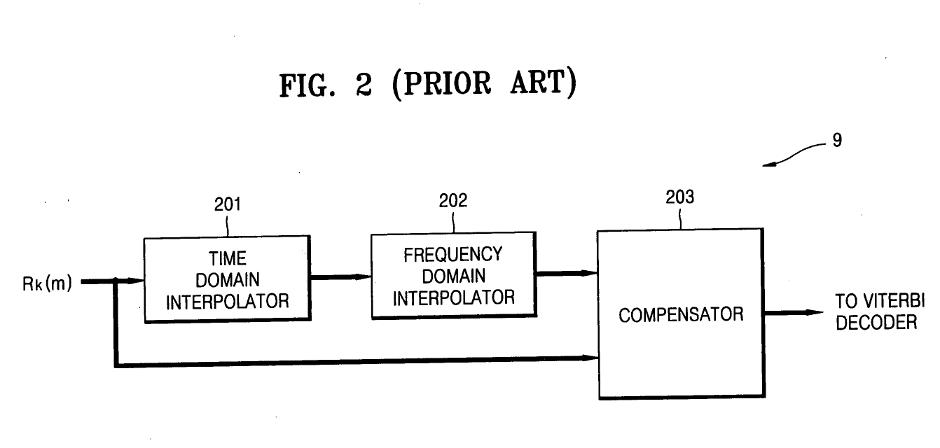

Compared to the conventional DVB-T receiver of FIG. 1, a DVB-T receiver of FIG. 4 further includes the STR controller 413 and its interaction with other blocks of FIG. 4. Also, the equalizer 409 of FIG. 5 is different from the equalizer 9, shown in FIG. 2, of the conventional DVB-T receiver.

The STR controller 413 stores the value of the channel selection signal CS and the value of the window movement indication signal FWM, and stores a first BER value generated by the BER calculator 412. The STR controller 413 changes the values of the channel selection signal CS and the window movement indication signal FWM, and outputs the changed channel selection signal CS and window movement indication signal FWM. The STR controller 413 compares the first BER value with a second BER value generated by the BER calculator 412 in response to the changed channel selection signal CS and window movement indication signal FWM. Then, the STR controller 413 selects and outputs the channel selection signal CS and the window movement indication signal FWM, or the changed channel selection signal CS and the changed window movement indication signal FWM, according to the result of comparison. In some embodiments, the STR controller 413 selects and outputs the channel selection signal CS and the window movement indication signal FWM, or the changed channel selection signal CS and window movement indication signal FWM, according to the combination that results in a smaller BER value.

To determine a desired (e.g., optimum) echo channel and the range of an FFT window for the optimum echo channel, the range of an optimum FFT window for a first kind of echo channel is determined by performing a predetermined operation. Next, a predetermined operation is performed on an input path signal to obtain a TS and a BER value, and the BER value and information regarding the first echo channel and the determined FFT window range are stored in the STR controller 413.

Next, the STR controller 413 sets a current channel to a second kind of echo channel, changes the FFT window range and CS value, and obtains a TS and a BER value. The range of the FFT window is changed by forwarding the FFT window by a GI of the received signal.

Next, the STR controller 413 compares a BER value in the first kind of echo channel with that in the second kind of echo channel, and the first or second kind of echo channel having a smaller BER value is selected.

Operations of a DVB-T receiver according to exemplary embodiments of the present invention receiving signals via the first or second kind of echo channels will now be described in greater detail. First, demodulating the received signals in the first kind echo channel will be described. Next, selecting an optimum CS value and the range of an FFT window by determining whether the two path signals can be more exactly demodulated using the second kind of echo channel or the first kind of echo channel will be described.

Before describing the operations of a DVB-T receiver according to exemplary embodiments of the present invention, three preconditions to be satisfied will be described, according to some embodiments of the invention.

First, the bandwidth B of the FIR filter 502-1 corresponding to the first and second kind of echo channels should satisfy the following:
B<Tᵤ/3 (1),
wherein Tᵤ denotes the duration of an OFDM symbol.

Second, a time spread τ of the echo channels should satisfy the following:
GI<τ<B<Tᵤ/3 (2)

When the time spread τ is greater than the GI and less than the bandwidth B, thus satisfying Equation (2), it is possible to effectively select an optimum CS value and the range of the FFT window by moving the FFT window by the GI only once.

Third, carrier-to-noise ratios (CNRs) of the echo channels should be large enough for the DVB-T receiver to normally operate. If the CNRs are too small, the DVB-T receiver may not operate in both the echo channels.

In addition, it is assumed that the STR controller 413 sets the values of the window movement indication signal FWM and the channel selection signal CS to 0.

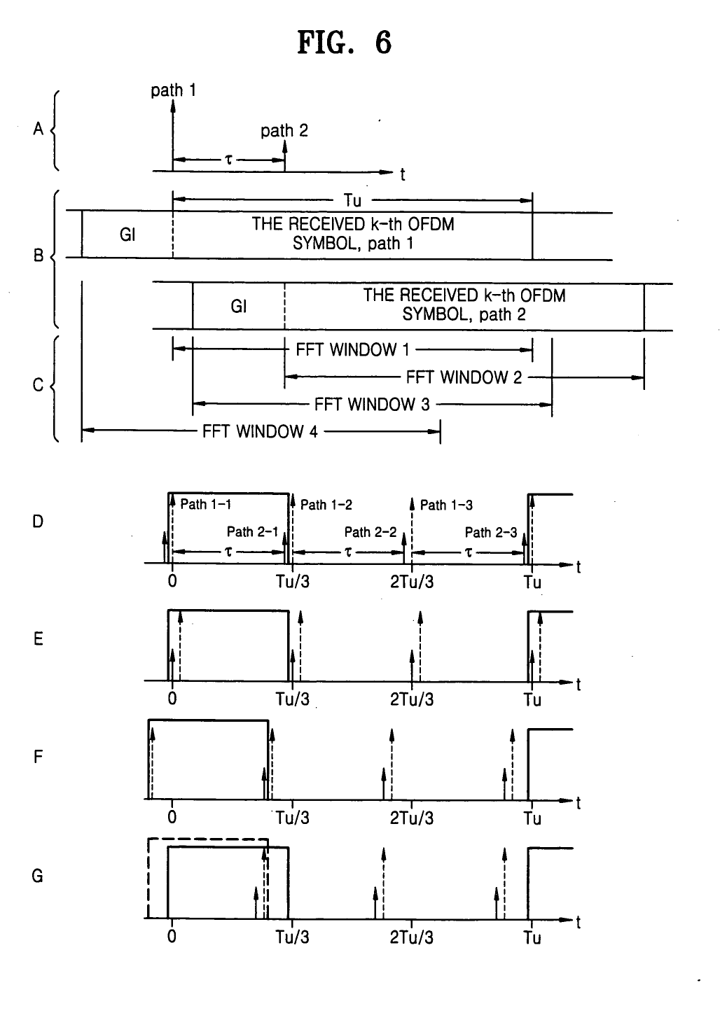

FIG. 6 illustrates details of a two-ray multipath channel with channel profile path 1 and path 2 and four FFT windows therefor according to exemplary embodiments of the present invention. Specifically, (A) of FIG. 6 illustrates the channel profiles of the path signals path 1 and path 2. (B) of FIG. 6 illustrates the data structures of the received OFDM signal via the two-ray multipath channel. (C) of FIG. 6 illustrates the ranges of the four FFT windows. (D) of FIG. 6 illustrates a process of estimating a channel using a first FFT window. (E) of FIG. 6 illustrates a process of estimating a channel using a second FFT window. (F) of FIG. 6 illustrates a process of estimating a channel after moving the second FFT window forward by a GI. (G) of FIG. 6 illustrates a process of estimating a channel after moving the first FFT window forward by the GI.

Referring to (A) of FIG. 6, the amplitude of the first path signal path 1 is greater than that of the second path signal path 2.

Referring to (B) of FIG. 6, a k^{th} OFDM symbol is activated for a symbol duration Tᵤ, and a time spread τ of the two-ray channel, i.e., time interval between the first and second path signals path 1 and path 2, is greater than the GI of the received OFDM signal.

Referring to (C) of FIG. 6, the durations of the first through fourth FFT windows are equal to one another, but they start at different times. It is possible to detect an optimum window from the first through fourth FFT windows by performing an operation.

Referring to FIG. 6, it is assumed that the first FFT window begins at the interface between the GI and the k^{th} OFDM symbol of the first path signal path 1, and the second FFT window begins at the interface between the GI and the k^{th} OFDM symbol of the second path signal path 2.

Referring to (D) and (G) of FIG. 6, the first FFT window of (D) of FIG. 6 can best demodulate the symbols of the first and second path signals path 1 and path 2. Referring to (D) of FIG. 6, the first and second path signals path 1 and path 2 are generated at the both edges of the first FFT window, thereby minimizing aliasing between the path signals path 1 and path 2. In contrast, referring to (G) of FIG. 6, when a current channel is reset to a second echo channel and the first FFT window is moved forward by the GI, aliasing between the first and second path signals path 1 and path 2 happens, which may prevent the path signals path 1 and path 2 from being exactly demodulated.

Referring to (D) through (G) of FIG. 6, the symbol duration Tᵤ is divided into three parts, and the channel impulse responses of the path signals path 1 and path 2 are divided according to the division of the symbol duration Tᵤ. Here, long, dashed arrows indicate the channel impulse responses Path 1-1, Path 1-2, and Path 1-3 of the first path signal path 1. Short, solid arrows indicate the channel impulse responses Path 2-1, Path 2-2, and Path 2-3 of the second path signal path 2. The channel impulse responses Path 1-1 through Path 2-3 may be RGB signals.

FIG. 6 illustrates that use of the first FFT window in the first kind of echo channel may be the most desirable in these embodiments. Accordingly, when exemplary embodiments of the present invention are actually used, whether the first or the second kind of echo channel is better may be determined.

It is assumed that an FFT window shown in (E) of FIG. 6 is used to process path signals. Referring to (E) of FIG. 6, the path signals path 1 and path 2 do not appear to be exactly demodulated using the FFT window set for the first kind of echo channel. However, when the coefficients of the frequency domain interpolation corresponding to a current echo channel are reset to those corresponding to the second kind of echo channel and the FFT window is moved forward by a GI, it is possible to more precisely demodulate the path signals path 1 and path 2 as shown in (F) of FIG. 6.

Referring again to FIG. 4, after the input signal γ(t) is synchronized by the coarse STR & CR block 403, the fine CR block 405, and the fine STR block 408, the BER calculator 412 compares the signal output from the Viterbi decoder 410 with the signal output from the Reed-Solomon decoder 411 to obtain a quasi BER value. When the DVB-T receiver 400 operates normally, the BER value output from the BER calculator 412 can be less than 10⁻³˜10⁻⁴. When an output of the BER calculator 412 is stable for a predetermined length of time, the BER value is stored in the STR controller 413. It is assumed that the values of the window movement indication signal FWM and the channel selection signal CS are set to 0 according to the stored BER value.

Next, the STR controller 413 resets the value of the window movement indication signal FWM according to the GI so that the FFT block 404 moves a current FFT window forward by the GI, and resets the value of the channel selection signal CS to 1 to operate the equalizer 409 for the second kind of echo channel. When the value of the channel selection signal CS is set to 1, the equalizer 409 performs channel estimation and compensation of the frequency domain complex signal Rₖ(m) using the FIR filter 502-1 with the band characteristics corresponding to the second kind of echo channel. When the value of the window movement indication signal FWM is set according to the GI, the channel selection signal CS has a value of 1, and a predetermined length of time passes, the BER calculator 412 outputs a stable output.

The STR controller 413 compares a BER value computed when FWIN_Move=GI and CS=1 with a BER value computed when FWIN_Move=0 and CS=0. If the BER value computed when FWIN_Move=0 and CS=0 is much less than the BER value computed when FWIN_Move=GI and CS=1, the STR controller 413 resets FWIN_Move and CS to 0. Otherwise, FWIN_Move=GI and CS=1 are maintained.

Referring again to (G) of FIG. 6, the CIR estimation that is obtained in a channel by using the fourth FFT window obtained by moving the first FFT window forward by the GI is incorrect. In this case, the BER calculator 412 outputs a large BER value of about 0.5. The STR controller 413 compares the current BER value with a previously stored BER value, and a channel selection signal CS and a window movement indication signal FWM corresponding to the smaller of the current and previous BER values is output. Therefore, the values of the window movement indication signal FWM and the channel selection signal CS are set to 0.

As described above, DVB-T receivers, methods and computer program products according to exemplary embodiments of the present invention can use a plurality of echo channels and can change the range of an FFT window to be used in each of the echo channels in order to demodulate a multipath signal. Therefore, it is possible to select an optimum echo channel and FFT window for the multipath signal.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A digital video broadcasting terrestrial (DVB-T) receiver comprising:
an analog-to-digital converter that is configured to sample an analog signal transmitted from a DVB-T transmitter;
a demodulator that is configured to demodulate the analog signal sampled by the analog-to-digital converter and that is configured to output a complex signal from a sampled signal and a complex carrier signal in response to a fine frequency offset signal;
a coarse symbol timing recovery (STR) and carrier recovery (CR) block that is configured to receive the complex signal and that is configured to generate a coarse offset signal indicating a Fast Fourier transform (FFT) start position and a coarse frequency offset signal containing frequency offset information of the complex signal;
an FFT block that is configured to subtract a guard interval from the complex signal and that is configured to generate a frequency domain complex signal in response to the coarse offset signal, a fine offset signal associated with the FFT start position, and a window movement indication signal;
a fine STR block that is configured to generate the fine frequency offset signal offset from the sampled signal and the fine offset signal, the fine frequency offset signal being generated from the frequency domain complex signal output from the FFT block;
a fine CR block that is configured to generate a fine frequency offset signal offset from the complex carrier signal from the frequency domain complex signal output from the FFT block;
an adder that is configured to combine the coarse frequency offset signal and the fine frequency offset signal offset from the complex carrier signal;
a number-controlled oscillator that is configured to generate the complex carrier signal in response to a signal output from the adder;
an equalizer that is configured to perform channel estimation and compensation by performing a predetermined operation on the frequency domain complex signal in response to a channel selection signal;
a Viterbi decoder that is configured to perform Viterbi decoding of the compensated frequency domain complex signal output from the equalizer, and that is configured to output a real frequency signal;
a Reed-Solomon decoder that is configured to generate a Transport Stream (TS) from the real frequency signal output form the Viterbi decoder;
a bit error rate (BER) calculator that is configured to compare the real frequency signal output from the Viterbi decoder with the TS output from the Reed-Solomon decoder, to obtain a first BER value; and
an STR controller that is configured to generate the channel selection signal and the window movement indication signal from the first BER value output from the BER calculator, the channel selection signal allowing channel selection and the window movement indication signal indicating a change in the range of a window used for an FFT operation.

2. The DVB-T receiver of claim 1, wherein the STR controller is configured to store the value of the channel selection signal, the value of the window movement indication signal, and the first BER value computed by the BER in response to the channel selection signal and the window movement indication signal; is further configured to change and output the values of the channel selection signal and the window movement indication signal; is further configured to compare the first BER value with a second BER value generated by the BER calculator in response to the changed channel selection signal and the window movement indication signal; and is further configured to select and output the values of the channel selection signal and the window movement indication signal or the values of the changed channel selection signal and window movement indication signal according to a result of comparison.

3. The DVB-T receiver of claim 2, wherein if the first BER value is less than the second BER value, the selected values are the values of the channel selection signal and the window movement indication signal, and if the second BER value is less than the first BER value, the selected values are the values of the changed channel selection signal and window movement indication signal.

4. The DVB-T receiver of claim 1, wherein the FFT block performs an FFT operation in response to the window movement indication signal while changing the range of the FFT window.

5. The DVB-T receiver of claim 4, wherein the range of the FFT window corresponds to a guard interval of the frequency domain complex signal.

6. The DVB-T receiver of claim 1, wherein the equalizer comprises:
a time domain interpolator that is configured to interpolate the frequency domain complex signal in a time domain;
a frequency domain interpolator that is configured to interpolate a signal output from the time domain interpolator in a frequency domain, in response to the channel selection signal; and
a compensator that is configured to perform channel estimation and compensation by comparing the signal output from the time domain interpolator with a signal output from the frequency domain interpolator.

7. The DVB-T receiver of claim 6, wherein the frequency domain interpolator comprises:
a filter coefficient storage unit that is configured to store two different types of filter coefficients and that is configured to output filter coefficients corresponding to the channel selection signal; and
a finite impulse response filter that is configured to filter the signal output from the time domain interpolator using filter coefficients transmitted from the filter coefficient storage unit.

8. The DVB-T receiver of claim 7, wherein the finite impulse response filter comprises a low pass filter.

9. A method of selecting a channel and a fast Fourier transform (FFT) window to be used in a digital video broadcasting terrestrial (DVB-T) receiver which includes a plurality of channels capable of demodulating an input multipath signal, the method comprising:
computing a first bit error rate (BER) value responsive to setting the value of a channel selection signal and the value of a window movement indication signal to predetermined values and demodulating an input multipath signal using the predetermined values;
computing a second BER value responsive to changing the values of the channel selection signal and the window movement indication signal and demodulating the input multipath signal using the changed values; and
determining a channel and a window range to be used to demodulate the input multipath signal by comparing the first and second BER values,
wherein the channel selection signal designates one of the plurality of channels, and
wherein the window movement indication signal indicates that the range of a window is to be adjusted when demodulating the received multipath signal using an FFT operation on the designated channel.

10. The method of claim 9, wherein the range of the window to be moved in response to the window movement indication signal is equal to the value of a guard interval of the multipath signal.

11. The method of claim 9, wherein the computation of the first BER value comprises:
storing the values of the channel selection signal and the window movement indication signal;
demodulating the multipath signal in response to the channel selection signal and the window movement indication signal; and
storing the first BER value obtained by demodulating the multipath signal.

12. The method of claim 9, wherein the computation of the second BER value comprises:
resetting the values of the channel selection signal and the window movement indication signal;
demodulating the multipath signal in response to the reset channel selection signal and the window movement indication signal; and
storing the second BER value obtained by demodulating the multipath signal.

13. The method of claim 9, wherein the determination of the channel and the window range comprises:
comparing the first and second BER values; and
selecting the channel and the window range according to the result of comparison.

14. The method of claim 13, wherein the selected channel and window range are determined using the smaller of the first and second BER values.

15. A digital video broadcasting terrestrial (DVB-T) receiver comprising:
a fast Fourier transformer that is configured to generate a frequency domain signal from a demodulated DVB-T signal using a range of a window;
an equalizer that is configured to equalize the frequency domain signal according to a channel selection to generate an equalized frequency domain signal; and
a controller that is responsive to a measure of a bit error rate of the equalized frequency domain signal to control the channel selection for the equalizer and to control the range of the window used by the fast Fourier transformer.

16. A DVB-T receiver of claim 15 wherein the controller is configured to maintain the channel selection for the equalizer and the range of the window used by the fast Fourier transformer in response to a decreasing measure of the bit error rate and to change the channel selection for the equalizer and the range of the window used by the fast Fourier transformer in response to an increasing measure of the bit error rate.

17. A computer program product that is configured to provide the DVB-T receiver of claim 15.

18. A digital video broadcasting terrestrial (DVB-T) receiving method comprising:
fast Fourier transforming a demodulated DVB-T signal using a range of a window to generate a frequency domain signal;
equalizing the frequency domain signal according to a channel selection to generate an equalized frequency domain signal; and
controlling the channel selection for the equalizer and the range of the window used by the fast Fourier transformer responsive to a measure of the bit error rate of the equalized frequency domain signal.

19. A DVB-T receiving method of claim 17 wherein the controller comprises:
maintaining the channel selection for the equalizer and the range of the window used by the fast Fourier transformer in response to a decreasing measure of the bit error rate; and
changing the channel selection for the equalizer and the range of the window used by the fast Fourier transformer in response to an increasing measure of the bit error rate.

20. A computer program product that is configured to provide the DVB-T receiving method of claim 18.
